(19) United States
(12) Patent Application Publication
(10) Pub. No.: US 2026/0179121 A1
(43) Pub. Date: Jun. 25, 2026

(54) ADVERTISEMENT METHOD, ADVERTISEMENT SYSTEM, AND ADVERTISEMENT MANAGEMENT METHOD

(71) Applicant: SEIKO EPSON CORPORATION, Tokyo (JP)

(72) Inventors: Takenori TATEIWA, MATSUMOTO-SHI (JP); Yuji KAWASE, MATSUMOTO-SHI (JP)

(21) Appl. No.: 19/429,495

(22) Filed: Dec. 22, 2025

(30) Foreign Application Priority Data
Dec. 24, 2024 (JP) 2024-227216

(51) Int. Cl. G06Q 30/0251

(52) U.S. Cl. CPC G06Q 30/0259

(57) ABSTRACT

An advertisement method includes: acquiring, by a second management device, first advertisement information indicating an advertisement of a first store from a first management device that manages advertisement information of a plurality of actual stores including the first store; acquiring, by a display device, the first advertisement information from the second management device; displaying, by the display device, the advertisement of the first store in a public place in a size viewable by multiple persons based on the first advertisement information; acquiring, by the second management device, visit information on a visitor to the first store; and transmitting, by the second management device, information related to an advertisement cost to the first management device based on the visit information, in which the visitor is a person who visits the first store based on the advertisement of the first store displayed in the public place.

The present application is based on, and claims priority from JP Application Serial Number 2024-227216, filed Dec. 24, 2024, the disclosure of which is hereby incorporated by reference herein in its entirety.

### BACKGROUND

### 1. Technical Field

The present disclosure relates to an advertisement method, an advertisement system, and an advertisement management method.

### 2. Related Art

Types of advertisements include an online advertisement and an outdoor advertisement. The online advertisement is, for example, an advertisement in which an image transmitted via the Internet is displayed on a terminal of a consumer. The outdoor advertisement includes, for example, an advertisement displayed on a signboard and an advertisement displayed in projection mapping using a building.

JP-A-2001-331524 discloses an example of an online advertisement. A retail store product advertisement system disclosed in JP-A-2001-331524 searches for retail store information including an advertisement target area or an advertisement period registered in advance based on area information transmitted from a consumer terminal, and transmits the searched retail store information to the consumer terminal.

JP-A-2001-331524 is an example of the related art.

However, there is a problem that it is difficult for an online advertisement provider to manage an outdoor advertisement using the technique in the related art. For example, a management burden is large when an online advertisement provider manages advertisements including an outdoor advertisement.

### SUMMARY

An example of an advertisement method according to the present disclosure includes: acquiring, by a second management device, first advertisement information indicating an advertisement of a first store from a first management device that manages advertisement information of a plurality of actual stores including the first store; acquiring, by a display device, the first advertisement information from the second management device; displaying, by the display device, the advertisement of the first store in a public place in a size viewable by multiple persons based on the first advertisement information; acquiring, by the second management device, visit information on a visitor to the first store; and transmitting, by the second management device, information related to an advertisement cost to the first management device based on the visit information, in which the visitor is a person who visits the first store based on the advertisement of the first store displayed in the public place.

An example of an advertisement system according to the present disclosure includes: a second management device; and a display device, in which the second management device acquires first advertisement information indicating an advertisement of a first store from a first management device that manages advertisement information of a plurality of actual stores including the first store, the display device acquires the first advertisement information from the second management device, the display device displays the advertisement of the first store in a size viewable by multiple persons in a public place based on the first advertisement information, the second management device acquires visit information on a visitor to the first store, the second management device transmits information related to an advertisement cost to the first management device based on the visit information, and the visitor is a person who visits the first store based on the advertisement of the first store displayed in the public place.

An example of an advertisement management method according to the present disclosure includes: managing advertisement information of a plurality of actual stores including a first store; transmitting first advertisement information indicating an advertisement of the first store to a second management device, and receiving information related to an advertisement cost from the second management device, in which the information related to the advertisement cost is information based on information related to a visitor who visits the first store based on the advertisement of the first store displayed in a public place.

### BRIEF DESCRIPTION OF THE DRAWINGS

FIG. 1 shows a configuration example including an advertisement system 1 according to a first embodiment.

FIG. 2 shows a configuration example of a first management device 10 shown in FIG. 1.

FIG. 3 shows a configuration example of a second management device 20 shown in FIG. 1.

FIG. 4 shows a configuration example of a mobile terminal 70 shown in FIG. 1.

FIG. 5 shows a configuration example of an advertisement viewer detection table 2204 shown in FIG. 3.

FIG. 6 shows a configuration example of a group constituent table 2205 shown in FIG. 3.

FIG. 7 shows a configuration example of a notification image timetable 2206 shown in FIG. 3.

FIG. 8 shows a configuration example of a notification viewer number table 2207 shown in FIG. 3.

FIG. 9 shows a configuration example of a notification use table 2208 shown in FIG. 3.

FIG. 10 shows a configuration example of a notification user number table 2209 shown in FIG. 3.

FIG. 11 shows a configuration example of an action history table 2210 shown in FIG. 3.

FIG. 12 shows a configuration example of an analysis table 2211 shown in FIG. 3.

FIG. 13 is a flowchart showing an outline of an operation example of the advertisement system 1.

FIG. 14 shows a detailed operation example of step S1 in FIG. 13.

FIG. 15 shows a detailed operation example of step S2 in FIG. 13.

FIG. 16 shows a detailed operation example of step S3 in FIG. 13.

FIG. 17 shows a part of a detailed operation of step S3a according to a modification.

### DESCRIPTION OF EMBODIMENTS

Hereinafter, embodiments of the present disclosure will be described with reference to the accompanying drawings.

### Embodiment 1

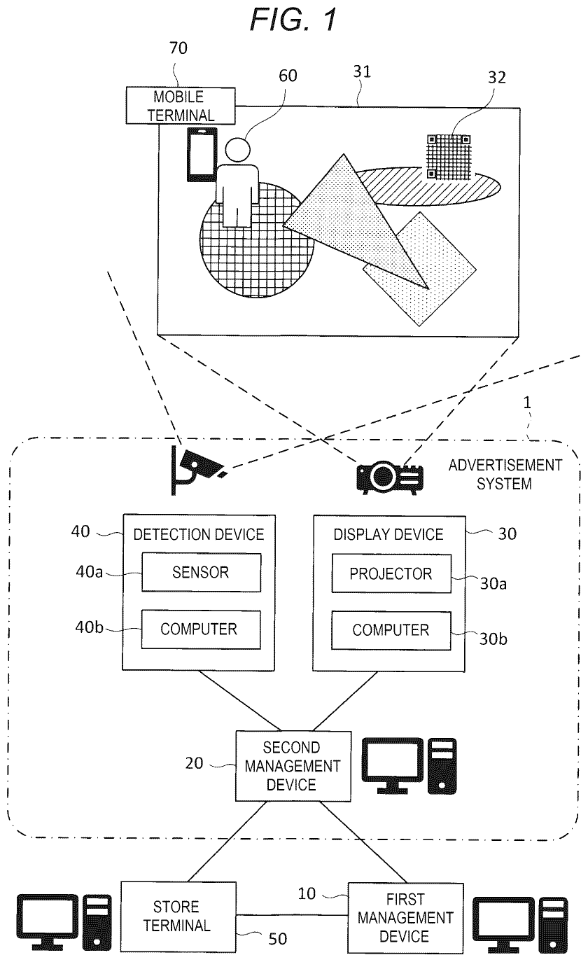

FIG. 1 shows a configuration example including an advertisement system 1 according to a first embodiment of the present disclosure. The advertisement system 1 is a system having a function of displaying an advertisement. The advertisement system 1 includes a second management device 20 and a display device 30. The advertisement system 1 may include a detection device 40. The advertisement system 1 executes an advertisement method according to the present embodiment. A first management device 10 executes the advertisement management method according to the present embodiment by using the advertisement system 1.

The first management device 10 is, for example, a computer managed by an online advertisement provider. An advertisement agency is an example of the online advertisement provider. The second management device 20 is, for example, a computer managed by another provider. The other provider is, for example, an administrator of an outdoor advertisement. Hereinafter, an administrator of the first management device 10 may be referred to as a “first provider”. An administrator of the second management device 20 may be referred to as a “second provider”. In the present specification, the “outdoors” is not necessarily limited to the outside of a building. For example, the indoors also includes a region having a wide space similar to outdoors or a space capable of accommodating a large number of persons similar to outdoors.

The advertisement system 1 displays an image 31 related to an advertisement in a public place. In particular, the display device 30 displays the image 31 related to an advertisement in a public place. The image 31 includes an image related to an advertisement, and may include an image not related to an advertisement. The image related to an advertisement includes an image representing an advertisement.

A person who views the image 31, particularly views the advertisement, is an advertisement viewer 60. Each advertisement viewer 60 has a mobile terminal 70. In the present specification, the term “view” refers to, for example, visual recognition. In addition, the term “view” may refer to recognition through at least one of an auditory sense, a tactile sense, an olfactory sense, and other senses in addition to a visual sense.

A store terminal 50 is provided for each of one or more stores to communicate with the first management device 10. The store terminal 50 is a terminal managed by an administrator of each store. Advertisements related to these stores are included in the image 31. In the present embodiment, each store terminal 50 can also communicate with the second management device 20, but this is not essential.

The store terminal 50 may be a specific terminal, or may be any terminal capable of accessing contact information registered in advance for a store. The contact information is, for example, a mail address. That is, the administrator of each store may be able to use any computer as the store terminal 50 at any time.

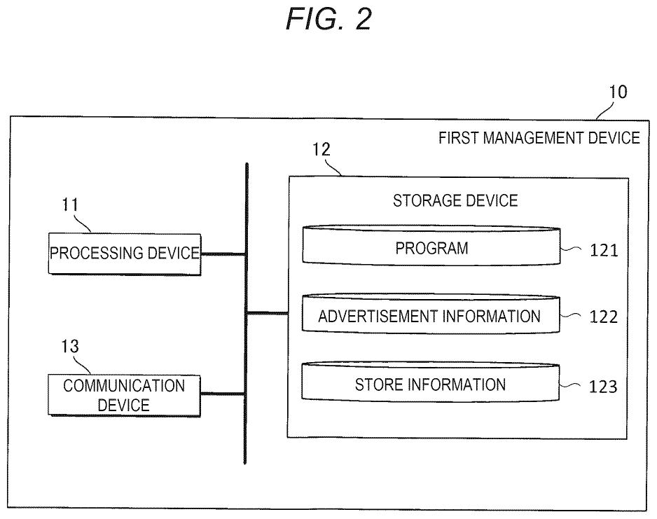

FIG. 2 shows a configuration example of the first management device 10. The first management device 10 has a hardware configuration as a known computer. The first management device 10 includes, for example, a processing device 11 and a storage device 12. The processing device 11 includes, for example, a processor. The processor can be manufactured using an integrated circuit, an application specific integrated circuit (ASIC), a field programmable gate array (FPGA), or the like. The storage device 12 includes a storage medium. The storage medium includes, for example, a semiconductor memory device, a magnetic disk device, and the like. A part or all of the storage medium may be a non-transitory storage medium.

Although not particularly shown, the first management device 10 may include at least one of an input device and an output device. The input device may include, for example, a keyboard and a mouse. The output device may include, for example, a display device and a printing device. The display device is, for example, a liquid crystal display device. The printing device is, for example, a printer.

The first management device 10 includes a communication device 13. The communication device 13 is, for example, a network interface. The communication device 13 transmits and receives information by communicating with an external device. The external device is, for example, a computer. The communication device 13 can perform at least one of wired communication and wireless communication. The communication device 13 may function as an input device. The communication device 13 may function as an output device.

The storage device 12 stores, for example, a program 121, advertisement information 122 including information related to an advertisement, and store information 123 including information related to a store that is a request source of an advertisement.

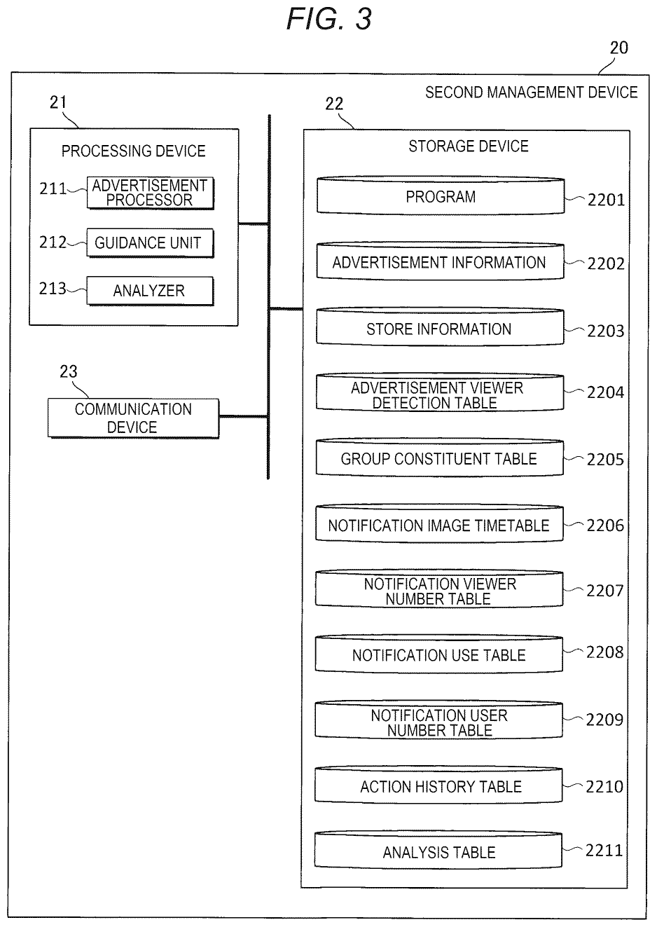

FIG. 3 shows a configuration example of the second management device 20. The second management device 20 has a hardware configuration as a known computer. The second management device 20 includes, for example, a processing device 21 and a storage device 22. The processing device 21 includes, for example, a processor. The processor can be manufactured using an integrated circuit, an ASIC, an FPGA, or the like. The storage device 22 includes a storage medium. The storage medium includes, for example, a semiconductor memory device, a magnetic disk device, and the like. A part or all of the storage medium may be a non-transitory storage medium.

Although not particularly shown, the second management device 20 may include at least one of an input device and an output device. The input device may include, for example, a keyboard and a mouse. The output device may include, for example, a display device and a printing device. The display device is, for example, a liquid crystal display device. The printing device is, for example, a printer.

The second management device 20 includes a communication device 23. The communication device 23 is, for example, a network interface. The communication device 23 transmits and receives information by communicating with an external device. The external device is, for example, a computer. The communication device 23 can perform at least one of wired communication and wireless communication. The communication device 23 may function as an input device. The communication device 23 may function as an output device.

The processing device 21 functions as an advertisement processor 211 that executes processing related to display of an advertisement or the like, a guidance unit 212 that executes processing related to guidance of the advertisement viewer 60 to a store, and an analyzer 213 that analyzes an effect of an advertisement.

The storage device 22 stores, for example, the following information.
A program 2201 that defines an operation of the second management device 20;
Advertisement information 2202 including information related to an advertisement;
Store information 2203 including information related to a store that is a request source of an advertisement;
An advertisement viewer detection table 2204 including information indicating a detection result of a person who viewed an advertisement. Hereinafter, a person who viewed an advertisement may be referred to as an “advertisement viewer”;
A group constituent table 2205 including information indicating a group constituent of advertisement viewers;
A notification image timetable 2206 including information indicating a display timing of a notification image related to an advertisement;
A notification viewer number table 2207 including information indicating the number of persons who viewed a notification image. Hereinafter, a person who viewed a notification image may be referred to as a “notification viewer”;
A notification use table 2208 including information indicating a detection result of a person who used the notification image among persons who viewed the notification image. Hereinafter, a person who used the notification image may be referred to as a “notification user”;
A notification user number table 2209 including information indicating the number of notification users;
An action history table 2210 including information indicating an action history of a notification user; and
An analysis table 2211 including information indicating a result obtained by analyzing an effect of an advertisement.

The display device 30 displays the image 31 related to an advertisement. An administrator of the display device 30 is, for example, a provider that manages the second management device 20. Alternatively, the administrator may be another provider.

The display device 30 includes, for example, a projector 30a that projects the image 31 by light and a computer 30b that controls an operation of the projector 30a. Another display device may be used instead of the projector 30a. For example, a liquid crystal display device may be used. The projector 30a can project the image 31 onto an appropriate projection region in a mode that the image 31 can be simultaneously viewed by multiple persons. The projection region is, for example, the ground or a road surface of an event venue. The projection region may be a projector screen, a building, a space in which mist is scattered, or the like. For example, a wall or a roof of a building can be used as a projection region.

The image 31 includes an advertisement. The image 31 may further include an image other than an advertisement. For example, when contents that attract viewer's interest in an event are displayed at the same time with an advertisement, the degree of attention to the advertisement can be increased. Another image may be superimposed and displayed on the image 31 or the advertisement. A layout of the image 31 or the advertisement may be changed as appropriate.

The computer 30b of the display device 30 may receive the advertisement information 2202 from the second management device 20 in advance and store the advertisement information 2202 in a storage device. The computer 30b of the display device 30 may receive the notification image timetable 2206 from the second management device 20 in advance. The computer 30b of the display device 30 may control the projector 30a according to the notification image timetable 2206.

The detection device 40 acquires information related to a person who views the image 31. The detection device 40 has, for example, a function as a human flow sensor. The detection device 40 includes a sensor 40a. The sensor 40a includes, for example, an imaging device that captures an image. The image may be a moving image or a still image. The imaging device is, for example, a camera. Further, the sensor 40a may include at least one of sensors such as a distance measuring device that measures a distance to a surrounding object, a pressure sensor that detects movement of a person, and a thermohygrometer that measures surrounding weather. Examples of the distance measuring device include a LiDAR sensor, a depth camera, and a stereo camera. An imaging range of the imaging device and a distance measuring range of the distance measuring device are, for example, a region including the entire image 31. The imaging range of the imaging device and the distance measuring range of the distance measuring device may further include a region outside the image 31. The region outside the image 31 is, for example, a region including the whole body of a person who views the image 31. A measurement region of the pressure sensor is, for example, a range in which a weight of a person who views the image 31 can be detected.

The detection device 40 includes a computer 40b as a control device that controls the sensor 40a. The computer 40b can acquire information related to a person based on the information acquired by the sensor 40a. The information related to a person includes, for example, information indicating age and a group relationship.

Although a configuration of the store terminal 50 is not particularly shown, for example, the store terminal 50 has a hardware configuration as a known computer. For example, the store terminal 50 includes a processing device, a storage device, a communication device, an input device, and an output device.

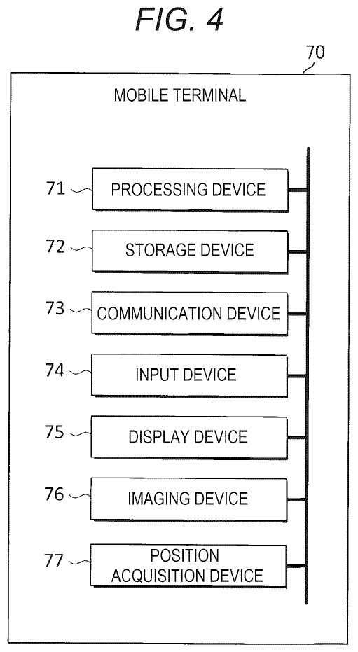

FIG. 4 shows a configuration example of the mobile terminal 70. The mobile terminal 70 has a hardware configuration as a known computer. For example, the mobile terminal 70 includes a processing device 71 and a storage device 72. The processing device 71 includes, for example, a processor. The processor can be manufactured using, for example, an integrated circuit. The storage device 72 includes a storage medium. The storage medium includes, for example, a semiconductor memory device. A part or all of the storage medium may be a non-transitory storage medium.

The mobile terminal 70 includes a communication device 73. The communication device 73 is, for example, a network interface including an antenna. The communication device 73 transmits and receives information by communicating with an external device. The external device is, for example, a base station or another computer. The communication device 73 performs wireless communication, and may perform wired communication. The communication device 73 may function as an input device or an output device.

The mobile terminal 70 further includes an input device 74, a display device 75, an imaging device 76, and a position acquisition device 77. The input device 74 includes, for example, a touch panel. The display device 75 includes, for example, a liquid crystal display device. The input device 74 and the display device 75 may be integrated into a single touch panel display. The imaging device 76 includes, for example, a camera. The imaging device 76 captures an image around the mobile terminal 70. The position acquisition device 77 acquires a position of the mobile terminal 70 using, for example, a GPS system.

When information of a specific method is encoded in an image captured by the imaging device 76, the mobile terminal 70 can decode and acquire the information. An example of the information of a specific method is a barcode. That is, when a barcode is included in an image, the mobile terminal 70 can acquire information represented by the barcode. For example, when a uniform resource locator (URL) of a web page related to a store is encoded into a barcode, the mobile terminal 70 accesses the URL in response to the imaging device 76 imaging the barcode. The mobile terminal 70 may be configured to obtain permission of an owner, that is, the advertisement viewer 60 before the access.

The storage device 72 stores, for example, a program (not shown). The program (not shown) may include a guidance program to be described later. The program of the mobile terminal 70 defines an operation of the mobile terminal 70. When the processing device 71 executes the program, the mobile terminal 70 implements functions described in the present embodiment. That is, the program causes a computer to function as the mobile terminal 70 according to the present embodiment.

Information stored in the storage device 12 of the first management device 10 will be described with reference to FIG. 2 again. The program 121 defines an operation of the first management device 10. When the processing device 11 executes the program 121, the first management device 10 implements functions described in the present embodiment. That is, the program 121 causes a computer to function as the first management device 10 according to the present embodiment.

The advertisement information 122 includes information representing an image of an advertisement related to each of a plurality of actual stores. The store includes a product sales store, a restaurant store, a sightseeing facility, an accommodation facility, a public facility, and the like. The store may include a tourist spot as a conceptual store. Therefore, the store may be rephrased as a facility. Here, the term “actual” refers to “actually present”. The term “actual” includes a case in which a store is present in the real world and a case in which a store is present in a specific region. In addition, the term “actual” excludes, for example, a store that is present only in a virtual space, but this interpretation is not limited. The virtual space here includes a so-called virtual reality space and an Internet space.

An image of an advertisement includes, for example, a moving image or a still image. The image of an advertisement may include sound. In this manner, the first management device 10 manages advertisement information of a plurality of actual stores including a first store. The “first store” is an expression referring to one or more specific stores. The “first store” does not exclude a plurality of stores even when the “first store” is expressed as a single store.

The advertisement information 122 may include information indicating a notification related to a store associated with an advertisement. Hereinafter, the information indicating a notification may be referred to as “notification information”. The notification information may include, for example, a URL. The URL may be a URL of a domain managed by the second management device 20. The notification information may include an image. Hereinafter, an image included in the notification information may be referred to as a “notification image”. The notification image is expressed in the form of, for example, a one-dimensional barcode or a two-dimensional barcode. A notification image 32 in FIG. 1 schematically shows an example of a two-dimensional barcode. The two-dimensional barcode is, for example, a QR code. The QR code is a registered trademark.

The notification image 32 can be expressed, for example, in a format integrated into an image of an advertisement. However, the notification image 32 may be stored as an image independent of the image of an advertisement. When the notification image 32 is an independent image, the notification image 32 is associated with any one image of an advertisement. When the notification image 32 is an independent image, the notification image 32 is displayed at a timing related to an image of an advertisement. The expression “displayed at a timing related to an image of an advertisement” includes, but is not limited to, a mode in which the notification image 32 is displayed at the same time with the image of the advertisement, a mode in which the notification image 32 is displayed in a part of a time zone in which the image of the advertisement is displayed, a mode in which the notification image 32 is displayed immediately after the image of the advertisement is displayed, and the like. In this manner, the display device 30 displays information indicating a URL related to a store in association with an advertisement of the store. Hereinafter, the URL may be referred to as a “first URL”. The first URL is, for example, a URL of a domain managed by the second management device 20.

The image 31 may include an image of a sightseeing spot near a store. In this case, advertisements of the store and images of a sightseeing spot near the store may be alternately displayed.

The store information 123 associates a store with information related to the store. The information related to a store includes, for example, information indicating a menu type and information indicating a seat configuration. The information indicating a menu type is information such as a store that provides a pot dish, a store that provides Chinese food, a store that provides Japanese food, a pub, or a bar. The information indicating a seat configuration is information such as whether there is a counter seat, whether there is a small table, whether there is a medium table, whether there is a hall, and whether there is a private room. As a specific example, information indicating that a store provides Chinese food and has a small table and a medium table is stored for a certain store.

Information stored in the storage device 22 of the second management device 20 will be described with reference to FIG. 3 again. The program 2201 defines an operation of the second management device 20. When the processing device 21 executes the program 2201, the second management device 20 implements functions described in the present embodiment. That is, the program 2201 causes a computer to function as the second management device 20 according to the present embodiment. In particular, when the program 2201 is executed by the processing device 21, the program 2201 causes the processing device 21 to function as the advertisement processor 211, the guidance unit 212, and the analyzer 213.

The advertisement information 2202 includes information representing an image of an advertisement related to each of a plurality of actual stores. The advertisement information 2202 may include a copy of at least a part of the above-described advertisement information 122.

The store information 2203 associates a store with information related to the store. The store information 2203 may include a copy of at least a part of the above-described store information 123.

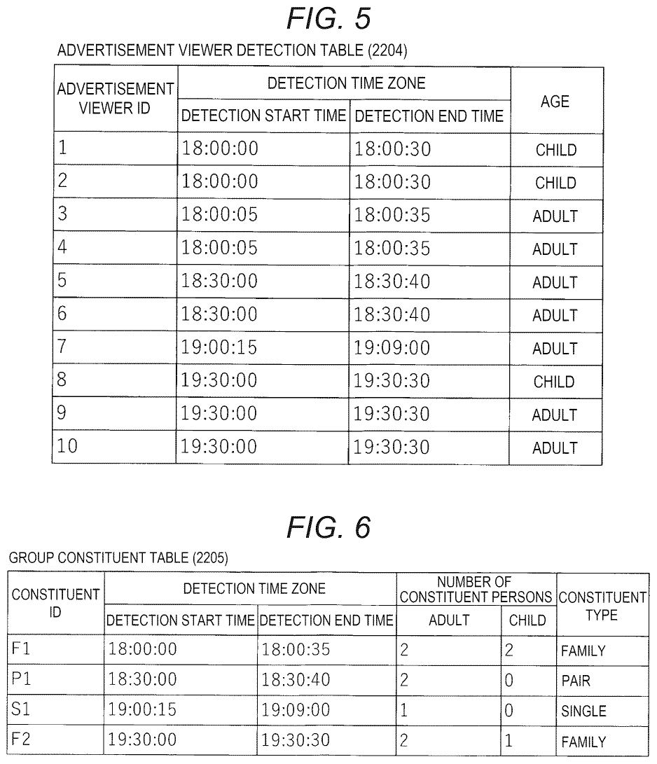

FIG. 5 shows a configuration example of the advertisement viewer detection table 2204. The advertisement viewer detection table 2204 includes information indicating a detection result of an advertisement viewer. For each person detected by the detection device 40, information for identifying an advertisement viewer is associated with information related to an advertisement viewer. The detection is performed by, for example, a human flow sensor. A detected person is an advertisement viewer. Hereinafter, the information for identifying an advertisement viewer may be referred to as an “advertisement viewer ID”. Here, all persons detected by the detection device 40 may be set as advertisement viewers. Alternatively, among persons detected by the detection device 40, only a person who satisfies a predetermined condition, for example, a person who has stopped for a predetermined time or more may be set as an advertisement viewer.

The information related to an advertisement viewer includes, for example, information indicating a detection time zone and age. The detection time zone includes, for example, a detection start time and a detection end time. The detection start time is a first time when an advertisement viewer is detected. The detection end time is a final time when an advertisement viewer is detected. The “time” in the present specification may include a date. The age indicates, for example, whether a person is an adult or a child. However, an expression form of the age can be freely designed, and may be expressed by era or a numerical value. The era is expressed as, for example, “20's”. The numerical value of age is expressed as, for example, “25 years old”.

FIG. 6 shows a configuration example of the group constituent table 2205. The group constituent table 2205 includes information indicating a group constituent of advertisement viewers. For each group including one or more advertisement viewers, information for identifying the group is associated with information related to the group. Hereinafter, the information for identifying the group may be referred to as a “constituent ID”.

The information related to the group includes, for example, information indicating a detection time zone, the number of constituent persons, and a constituent type. The detection time zone includes, for example, a detection start time and a detection end time. The detection start time is an earliest time among detection start times of advertisement viewers included in the group. The detection end time is a latest time among detection end times of advertisement viewers included in the group.

The number of constituent persons represents the number of advertisement viewers included in the group. In the present embodiment, the number of constituent persons is aggregated for each age, but may be aggregated for the entire group.

The constituent type includes information indicating a type of a group. The constituent type is “single”, for example, when a group includes only one advertisement viewer. For example, when a group includes two or more advertisement viewers, the constituent type is one of “pair”, “family”, “friend”, and the like according to a detection result of the detection device 40. The detection result of the detection device 40 includes, for example, information indicating the number of persons, a constituent type, and the like.

In the example of the present embodiment, four persons with advertisement viewer IDs of “1” to “4” constitute a group with a constituent ID of “F1”, that is, family. In the example of the present embodiment, two persons with advertisement viewer IDs of “5” and “6” constitute a group with a constituent ID of “P1”, that is, pair. In the example of the present embodiment, one person with an advertisement viewer ID of “7” constitutes a group with a constituent ID of “S1”, that is, a group of only a single advertisement viewer. In the example of the present embodiment, three persons with advertisement viewer IDs of “8” to “10” constitute a group with a constituent ID of “F2”, that is, family.

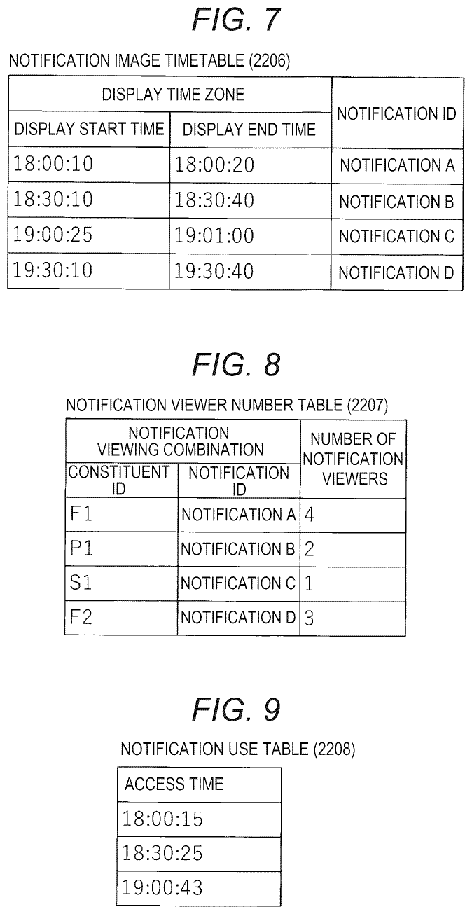

FIG. 7 shows a configuration example of the notification image timetable 2206. The notification image timetable 2206 includes information indicating a display timing of the notification image 32. For example, information for identifying the notification image 32 to be displayed is associated with each of one or more display time zones. Hereinafter, the information for identifying the notification image 32 may be referred to as a “notification ID”. The display time zone is defined by, for example, a display start time and a display end time.

The notification image timetable 2206 may be dynamically generated or changed. For example, the second management device 20 may change the notification ID at a time based on the time and a detection result of the detection device 40. Alternatively, the second management device 20 may change the notification ID in a time zone related to a time based on the time and a detection result of the detection device 40. The detection result of the detection device 40 may include, for example, contents of the group constituent table 2205 and a surrounding temperature. The surrounding temperature is, for example, an outside air temperature. In the present embodiment, only one notification ID is defined at one time point in the notification image timetable 2206. That is, the notification ID can be specified based on a time.

As a specific example, when a time is within a range of 18:00 to 19:00, a family of three to five persons is detected, and the outside air temperature is within a range of −10° C. to 0° C., one store that provides Chinese food and has a small table is extracted from stores stored in the store information 123. Then, a notification ID associated with the extracted store is stored as a notification ID corresponding to 18:00 to 19:00 in the notification image timetable 2206. On the other hand, when a time is within a range of 21:00 to 22:00, a pair is detected, and the outside air temperature is −10° C. or lower, a store that is a pub and has a private room is extracted from stores stored in the store information 123. An extraction rule can be freely defined, and for example, a store for children or family may be extracted in an early time zone, and a store for adults may be extracted in a late time zone.

A store may be extracted based on whether many men are detected or many women are detected. A store may be extracted based on a facial expression of a viewer. The rhythm of stepping by a viewer may be detected. A store may be extracted according to the detected rhythm.

A store may be extracted based on evaluation in social networking services (SNS). For example, information representing an SNS page of a store may be displayed together with an advertisement of the store. A store may be extracted according to the number of evaluations of “Like!” on the SNS page. Information representing the SNS page is, for example, a two-dimensional barcode obtained by encoding a URL.

FIG. 8 shows a configuration example of the notification viewer number table 2207. The notification viewer number table 2207 includes information indicating the number of persons who viewed a notification image, that is, the number of notification viewers. For each combination of a notification viewer and notification information viewed by the notification viewer, the number of persons corresponding to the combination is associated. Hereinafter, a combination of a notification viewer and notification information viewed by the notification viewer may be referred to as a “notification viewing combination”. Hereinafter, the number of persons corresponding to the combination may be referred to as “the number of notification viewers”. The notification viewer is identified by a constituent ID. The notification information viewed by a notification viewer is identified by the notification ID. FIG. 8 shows an example in which a group corresponding to a constituent ID of “F1” is viewing notification information corresponding to a notification ID of “notification A” and the group includes four notification viewers.

FIG. 9 shows a configuration example of the notification use table 2208. The notification use table 2208 indicates a detection result of a person who uses a notification image, that is, a notification user among notification viewers. For example, when a notification image is a barcode, the use of the notification image includes an operation for capturing the notification image using the mobile terminal 70 and an operation for permitting access to a URL encoded in the barcode.

Although only an access time is recorded in the example of FIG. 9, as a modification, a notification ID of a notification image used for access, information for identifying the mobile terminal 70 used for access, and the like may be associated with the access time. Hereinafter, the information for identifying the mobile terminal 70 may be referred to as a “terminal ID”.

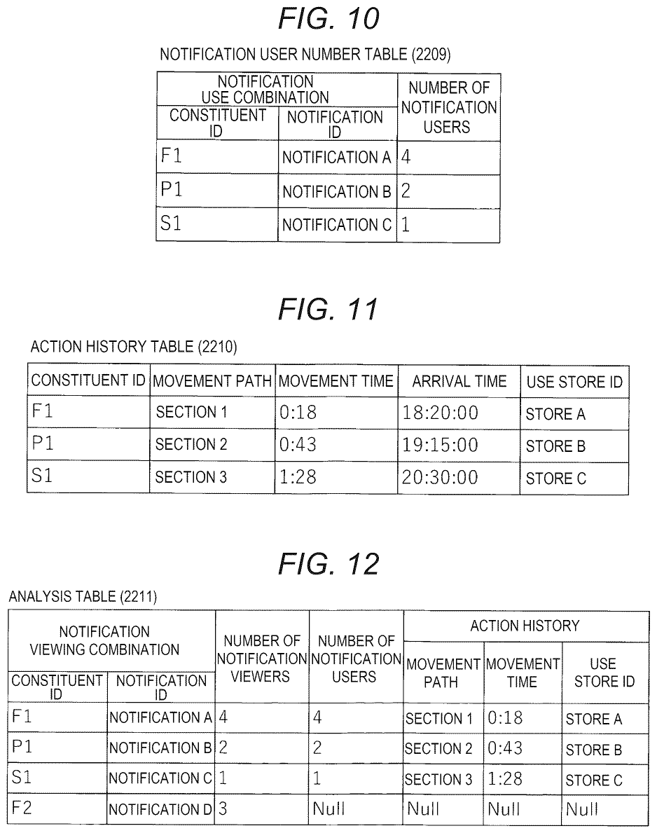

FIG. 10 shows a configuration example of the notification user number table 2209. The notification user number table 2209 includes information indicating the number of notification users. For each combination of notification user and used notification information, the number of persons corresponding to the combination is associated. Hereinafter, a combination of a notification user and used notification information may be referred to as a “notification use combination”. Hereinafter, the number of persons corresponding to the combination may be referred to as “the number of notification users”. A notification user is identified by a constituent ID, and the used notification information is identified by a notification ID.

FIG. 10 shows an example in which a group corresponding to a constituent ID of “F1” uses notification information corresponding to a notification ID of “notification A” and the group includes four notification users. Further, it can be seen from the examples in FIGS. 8 and 10 that a group corresponding to a constituent ID of “F2” viewed notification information corresponding to a notification ID of “notification D”, but does not use the notification information.

FIG. 11 shows a configuration example of the action history table 2210. The action history table 2210 includes information indicating an action history of a notification user. The notification user is identified by the constituent ID. The action history includes, for example, a movement path, a movement time, an arrival time, and a use store ID.

The movement path indicates a path along which a notification user used notification information and then moved. The path is, for example, a path along which a notification user who read a barcode using a mobile terminal has moved based on a map displayed on the mobile terminal in response to the reading of the barcode. An expression form of the movement path can be appropriately designed by those skilled in the art. The movement path is represented by, for example, a path start point and a path end point. The path start point and the path end point are each represented by, for example, a set of latitude and longitude. Each of the path start point and the path end point may be represented by a set of latitude, longitude, and altitude. The movement path may include a point in the middle of movement.

The movement time indicates a time required for a notification user to move. The arrival time indicates a time when a notification user arrives at a store or a time when moving of the notification user ends. The movement time may be a result of simply subtracting an access time from the arrival time. The movement time may be measured or calculated by another method.

The use store ID is information for identifying a store used by a notification user. Here, a notification image is associated with one store. That is, a notification ID is associated with one use store ID.

FIG. 12 shows a configuration example of the analysis table 2211. The analysis table 2211 includes visit information as information obtained by analyzing a display result of an advertisement. The visit information includes information related to a person who visits a store as a result of viewing an advertisement, that is, a visitor. The visitor is a visitor to a store. The visit information may further include information related to a person who views an advertisement and uses notification information but does not visit a store. The person who views an advertisement and uses notification information but does not visit a store is a person who is a notification user but is not a visitor.

In the analysis table 2211, information indicating the number of notification viewers, the number of notification users, and an action history is associated with each notification viewing combination. The action history is similar to a part of information shown in FIG. 11. “Null” in FIG. 12 indicates that information is not recorded in a corresponding item. For example, since a group corresponding to a constituent ID of “F2” does not use notification information corresponding to notification ID of “notification D”, the number of notification users and the action history are not recorded for this combination.

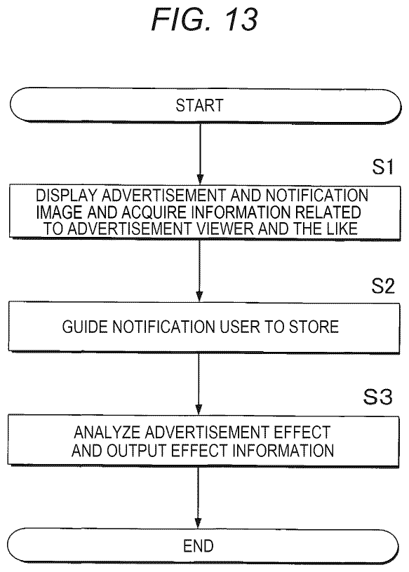

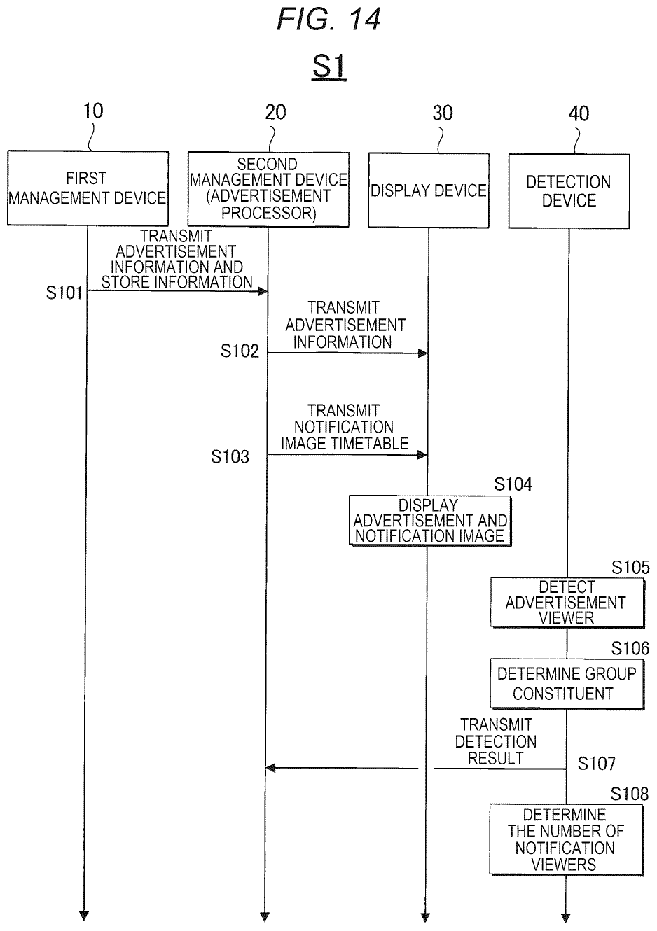

Hereinafter, an operation example of the advertisement system 1 will be described. Hereinafter, a case where an advertisement is displayed at a venue of an event and a participant of the event is guided to a store near the venue will be described as an example. FIG. 13 shows an outline of the operation, and FIGS. 14 to 16 show details of a part of the operation. FIGS. 13 to 16 show an advertisement method and an advertisement management method according to the present embodiment. The advertisement method is executed by, for example, the advertisement system 1 including the second management device 20. The advertisement management method is executed by, for example, the first management device 10.

FIG. 13 is a flowchart showing an outline of an operation example of the advertisement system 1. In step S1, the advertisement system 1 displays an advertisement and the notification image 32. In step S1, the advertisement system 1 acquires information related to the advertisement viewer 60 and the like via the detection device 40.

FIG. 14 shows a detailed operation example of step S1. In the operation shown in FIG. 14, processing executed by the second management device 20 is executed by, for example, the advertisement processor 211 in particular in the processing device 21.

Prior to step S1, the first management device 10 manages the advertisement information 122 of a plurality of actual stores. The plurality of stores include, for example, a first store. “Managing” information includes at least storing information in a storage device. In addition, “managing” information may include at least one of adding new information, updating information, deleting information, managing an expiration date of information, recording a history of information, transmitting information to and receiving information from an external device, and the like. In step S101 of step S1, the first management device 10 transmits the advertisement information 122 and the store information 123 to the second management device 20 before the event is held. In step S101, the second management device 20 receives the advertisement information 122 and the store information 123 and stores the advertisement information 122 and the store information 123 as the advertisement information 2202 and the store information 2203. In this manner, the second management device 20 acquires advertisement information of a store from the first management device 10. The advertisement information acquired here is, for example, first advertisement information indicating an advertisement of the first store.

Next, in step S102, the second management device 20 transmits the advertisement information 2202 to the display device 30. In step S102, the display device 30 receives and stores the advertisement information 2202. In this manner, the display device 30 acquires the advertisement information of the store.

Next, in step S103, the second management device 20 transmits the notification image timetable 2206 to the display device 30. In this step S103, the display device 30 receives and stores the notification image timetable 2206.

The execution order of steps S101 to S103 can be changed freely.

Although not shown in FIG. 14, an event is started after the completion of step S103. In order to collect a large number of participants in the event and bring the participants close to the image, it is preferable to know information on the event in advance.

After step S103, in step S104, the display device 30 displays the advertisement and the notification image 32 based on the notification image timetable 2206 and the advertisement information 2202. This step is executed, for example, during the event. Here, the advertisement is included in the image 31 and displayed in the present embodiment. In a public place, the display device 30 displays an advertisement of a store at a size viewable by multiple persons based on advertisement information of the store. The advertisement information of the store is, for example, the first advertisement information. For example, an advertisement is displayed as the image 31 including the advertisement.

Here, the “public place” is, for example, a public area. Even in a private area, a place where an unspecified number of persons can view the image 31 may correspond to the “public place”. Examples of the public place include a famous tourist spot or a part thereof, a large area or a part thereof, and a public facility or a part thereof. Further, there is no specific limitation on the “size viewable by multiple persons”. However, the “size viewable by multiple persons” may be defined as excluding, for example, a case where each advertisement viewer 60 individually views an advertisement using the mobile terminal 70.

In step S104, in order to make a participant more reliably view the notification image 32, it is preferable to stop the participant as long as possible. In order to stop a participant for a long time, it is preferable to display an image related to a season, an image of a venue, and the like to prompt the participant to view the image.

After step S103, in step S105, the detection device 40 detects an advertisement viewer. This step is executed, for example, after step S104 or in parallel with step S104. In the present embodiment, the detection device 40 includes a human flow sensor. Accordingly, the detection device 40 can detect the advertisement viewer 60 who views an advertisement at each time. Alternatively, the detection device 40 can detect the advertisement viewer 60 who views the image 31 at each time. In this manner, the detection device 40 acquires sufficient information for generating the advertisement viewer detection table 2204.

The detection of the advertisement viewer by the detection device 40 is executed, for example, as follows. First, the sensor 40a captures an image including an advertisement viewer. The sensor 40a transmits the image to the computer 40b. The computer 40b detects a person appearing in the image by image processing. The computer 40b recognizes the detected person as an advertisement viewer. The computer 40b assigns a unique advertisement viewer ID to each recognized advertisement viewer. The computer 40b further specifies age of each advertisement viewer by image processing. The computer 40b stores the age in association with the advertisement viewer ID.

In step S105, all persons detected by the detection device 40 may be treated as the advertisement viewers. Alternatively, only a person who satisfies a predetermined condition may be treated as an advertisement viewer. For example, only a person who is continuously detected for a predetermined time or more may be treated as an advertisement viewer. The predetermined time is, for example, 10 seconds.

Next, in step S106, the detection device 40 determines a group constituent for a plurality of the advertisement viewers 60. A method for determining the group constituent of the advertisement viewers can be designed freely. For example, the detection device 40 may have a function of determining the group constituent based on a detection result of the advertisement viewers. The detection device 40 may have a function of determining the group constituent based on an image captured by a camera. A person skilled in the art can appropriately design a method for determining the constituent type, that is, whether the advertisement viewers are a family or a pair, using a known technique or the like. For example, the computer 40b may determine whether the plurality of advertisement viewers are a family, a pair, friends, or have no relationship with one another based on age and position relationship of the plurality of advertisement viewers appearing in the image. In this manner, the detection device 40 acquires sufficient information for generating the group constituent table 2205.

Next, in step S107, the detection device 40 transmits information related to the advertisement viewers and the group constituent to the second management device 20. In step S107, the second management device 20 receives the information and stores the information in the advertisement viewer detection table 2204 and the group constituent table 2205.

Next, in step S108, the second management device 20 determines the number of notification viewers. In step S108, the second management device 20 first determines whether there is a time zone in which a detection time zone of a group and a display time zone of a notification image overlap each other based on the group constituent table 2205 and the notification image timetable 2206. When there is a time zone in which the detection time zone and the display time zone overlap each other, it is highly likely that the group viewed the notification image. When there is the overlapping time zone, the second management device 20 combines a corresponding constituent ID and notification ID as a notification viewing combination. Thereafter, the second management device 20 generates the notification viewer number table 2207 by setting the total number of persons of the corresponding constituent ID as the number of notification viewers.

The display device 30 may change the image 31 based on information related to a viewer. The viewer refers to at least one of an advertisement viewer and a notification viewer. For example, the image 31 may be changed according to the age of the viewer. Alternatively, the image 31 may be changed according to whether the viewer is a family or a pair. Information used by the display device 30 when changing the image 31 may be transmitted from the detection device 40 to the display device 30. Alternatively, the second management device 20 may determine whether to change the image 31 and how to change the image 31 based on the information related to the viewer. The second management device 20 may transmit a determination result to the display device 30. The display device 30 may receive the determination result from the second management device 20 and change the image 31 accordingly.

The image 31 may include an interactive image. That is, the display device 30 may change the image 31 according to an action of a viewer. As a more specific processing example, first, the detection device 40 detects an action of a viewer and transmits the action to the display device 30. The display device 30 changes the image 31 accordingly. Alternatively, the detection device 40 detects an action of a viewer and transmits the action to the second management device 20. Accordingly, the second management device 20 causes the display device 30 to change the image 31.

Hereinafter, a specific example of the interactive image will be described. When the image 31 is projected on a road surface, the image 31 may be changed according to a change in a position of a viewer relative to the image 31.

The image 31 may include a display of a number that is dynamically changed. When a viewer steps on the number, a next number is displayed at another location. This processing is repeated. After this processing is repeated a predetermined number of times, an advertisement and a notification image are displayed. In this manner, an advertisement can be displayed in a state in which the interest and the attention of a viewer are increased.

The image 31 may change according to stepping by a viewer. For example, when stepping is detected, information on a digital coupon that can be used in a store may be displayed together with an advertisement and a notification image. The information on the digital coupon may be integrated into the notification image.

As described above, the second management device 20 may acquire action information indicating an action of the advertisement viewer 60 who viewed an advertisement of a store based on a detection result of the detection device 40 in a public place.

The image 31 may be changed according to a time or may be changed according to reaction of a viewer to a voice. The image 31 may be changed according to the reaction of a viewer to a change in an image size.

The detection device 40 may detect a viewer who is about to enter a region of a road surface where the image 31 is projected from the outside of the region. When such a viewer is detected, the display device 30 may display an advertisement and a notification image before the viewer enters the region. This makes it easier to avoid a state in which the advertisement or the notification image is blocked by the body of the viewer.

The second management device 20 may store information indicating a congestion degree for each store and each time zone. Further, when a congestion degree of a store in a time zone is high, a display frequency of a notification image of the store in the time zone may be reduced. This makes it easier to avoid a situation in which a user actually visits the store but cannot enter the store due to full capacity.

Here, a function sharing between the detection device 40 and the second management device 20 in steps S105 to S108 can be freely changed. For example, the second management device 20 may execute step S106 instead of the detection device 40. Alternatively, the detection device 40 may execute step S108 instead of the second management device 20. In these modifications, a person skilled in the art can appropriately design transmission and reception timings of information and contents to be transmitted and received in step S107.

Step S1 is executed as described above. After step S1 or in parallel with step S1, the advertisement system 1 guides a notification user to a store in step S2.

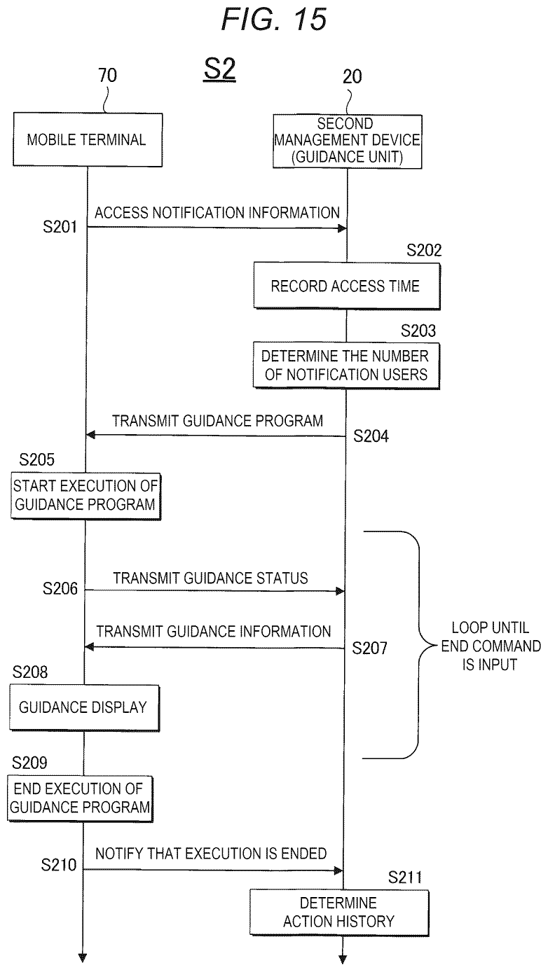

FIG. 15 shows a detailed operation example of step S2. In the operation shown in FIG. 15, processing executed by the second management device 20 is executed by, for example, the guidance unit 212 in particular in the processing device 21.

The execution of step S2 is started in response to the access of notification information by the mobile terminal 70 in step S201. For example, the advertisement viewer 60 who is viewing an advertisement and is interested in the advertisement uses the notification n image 32 associated with the advertisement. A specific example of such a use is an operation in which the mobile terminal 70 causes the imaging device 76 to capture the notification image 32, decodes an URL encoded into the notification image 32, and then transmits an access request to the URL. This URL is, for example, the first URL described above.

In step S202, the second management device 20 records a time when the notification information was accessed. For example, a new record is added to the notification use table 2208. Here, when a URL of a domain managed by the second management device 20 is encoded into the notification information, the second management device 20 can directly detect access to the notification information. Alternatively, when a URL of a domain managed by another server or the like is encoded into notification information, the other server or the like may redirect the access to the second management device 20.

In the present embodiment, only an access time is recorded. However, as a modification, a notification ID of the notification image used for the access, a terminal ID for identifying the mobile terminal 70 used for the access, and the like may be associated with the access time. For the notification ID, for example, the second management device 20 can acquire the notification ID in response to the access by encoding the notification ID as a part of the URL in the notification image 32.

Next, in step S203, the second management device 20 determines the number of persons involved in the access, that is, the number of notification users. That is, the number of notification users who have used the notification image is determined in step S203. Here, the number of notification users may be the number of persons of a group to which the notification users belong. A method of determining the number of persons can be appropriately designed by those skilled in the art, and a non-limiting specific example will be described below.

For example, the detection device 40 may detect that the advertisement viewer 60 has used the notification image 32. For example, the computer 40b may detect an action of the advertisement viewer 60 based on an image captured by the sensor 40a. In particular, the computer 40b may detect that the advertisement viewer 60 used the mobile terminal 70 of the advertisement viewer 60 to capture an image of a region where the notification image 32 is displayed. The computer 40b may determine that the advertisement viewer 60 used the notification image 32 based on this detection. In this manner, it is possible to specify which advertisement viewer 60 used the notification image based on a detection time and an access time recorded in the notification use table 2208. That is, a constituent ID can be specified. After the constituent ID is specified, the second management device 20 can acquire the number of persons in the group, that is, the number of notification viewers, with reference to the notification viewer number table 2207. The second management device 20 can set the number of persons acquired in this manner as the number of notification users.

Next, in step S204, the second management device 20 transmits a guidance program to the mobile terminal 70. In step S204, the mobile terminal 70 receives the guidance program. Next, in step S205, the mobile terminal 70 starts executing the guidance program. The execution of the guidance program is controlled via, for example, an HTML file. In association with the execution of the guidance program, control information and the like may be transmitted and received between the second management device 20 and the mobile terminal 70. Transmission and reception of the control information and the like may be executed according to, for example, an HTTP protocol or an HTTPS protocol.

The mobile terminal 70 may output information for guiding a notification user by executing the guidance program. For example, the mobile terminal 70 displays a map image centered on a position of the mobile terminal 70. The mobile terminal 70 displays by superimposing a figure indicating a position of the mobile terminal 70, a figure indicating a position of a store: related to the used notification image, and an arrow indicating a path on the map image.

As a modification, the guidance program may be stored in advance in the mobile terminal 70. In this case, in step S204, the second management device 20 may transmit a command to start execution of the guidance program to the mobile terminal 70.

In step S206, the mobile terminal 70 transmits a guidance status to the second management device 20 by executing the guidance program. In step S206, the second management device 20 receives the guidance status. The guidance status includes, for example, information indicating a position of the mobile terminal 70.

In step S207, the second management device 20 generates guidance information according to the guidance status and transmits the guidance information to the mobile terminal 70. In step S207, the mobile terminal 70 receives the guidance information. The guidance information is information for guiding the advertisement viewer 60 to a store. Considering step S201, it can be said that the second management device 20 transmits the guidance information for guiding a visitor to a store in response to access to notification information from the mobile terminal 70. The notification information represents, for example, the first URL related to the store.

The guidance information includes, for example, information related to an arrow indicating a path to the store on the map image. Contents of the guidance information may be changed according to a position of the mobile terminal 70. In step S208, the mobile terminal 70 performs guidance display according to the guidance information. When the guidance display has already been performed, the mobile terminal 70 performs new guidance display. That is, the mobile terminal 70 changes contents of the guidance display. In the guidance display, for example, a figure indicating the position of the mobile terminal 70, a figure indicating the position of the store related to the used notification image, and the arrow indicating the path are displayed in a manner of being superimposed on a map image centered on the position of the mobile terminal 70.

Steps S206 to S208 described above are executed in a loop until a predetermined end command is input to the mobile terminal 70. The end command is transmitted from the second management device 20 to the mobile terminal 70, for example, in response to a matter that the mobile terminal 70 arrives at the store, and accordingly the end command is input to the mobile terminal 70. Alternatively, the mobile terminal 70 may generate an end command in response to a matter that the mobile terminal 70 arrives at the store, and may proceed with the processing on the assumption that the end command is input.

Here, when the mobile terminal 70 arrives at the store, it can be said that an owner of the mobile terminal 70 is a visitor who visits the store. That is, the visitor is a person who visits the store based on an advertisement of the store displayed in a public place. It can be said that the second management device 20 acquires information related to a visitor, that is, visit information. Further, it can be said that the second management device 20 acquires the visit information based on information indicating the position of the mobile terminal 70 after the guidance information is transmitted. The visit information acquired here includes, for example, the movement path described above. According to such a configuration, a subsequent action of the advertisement viewer who is interested in the advertisement can be tracked with high accuracy.

The visit information includes information indicating a position of a visitor. Here, when a notification user does not finally visit a store, the visitor includes the notification user. For example, the visit information includes information indicating a position of the notification user. The position of the visitor may be represented by the position of the mobile terminal 70. The visit information may include information indicating a change in the position of the visitor. The information indicating the change in the position of the visitor includes, for example, the movement path described above. The visit information may include at least one of a detection start time and a detection end time of an individual visitor, a detection start time and a detection end time of a group to which a visitor belongs, the number of constituent persons and a constituent type of a group, a viewed notification ID, a used notification ID, a movement time, an arrival time, and a use store ID, or may include other kinds of information.

A person skilled in the art can appropriately design a method of determining whether the mobile terminal 70 arrives at a store. For example, when a distance between the mobile terminal 70 and the store is equal to or less than a predetermined reference, it may be determined that the mobile terminal 70 arrives at the store.

Alternatively, when the mobile terminal 70 transmits an access request to a predetermined URL related to a store, it may be determined that the mobile terminal 70 arrives at the store. For example, when a predetermined URL is encoded in a barcode posted only in the store, it can be said that a notification user reading the barcode using the mobile terminal 70 indicates that the mobile terminal 70 arrives at the store.

Alternatively, when the store terminal £50 acquires information representing the mobile terminal 70, it may be determined that the mobile terminal 70 arrives at the store. For example, the second management device 20 transmits information for identifying the mobile terminal 70 to the mobile terminal 70. The information for identifying the mobile terminal 70 is, for example, a two-dimensional barcode image. The store terminal 50 may read the information from the mobile terminal 70 in response to an operation of a store clerk or a notification user and transmit the read information to the second management device 20. The second management device 20 may determine that the mobile terminal 70 arrives at the store in response to the reception of the information from the store terminal 50.

Alternatively, a notification user may input an end command to the mobile terminal 70 as an operation to end the execution of the guidance program. Here, it is assumed that the guidance program is executed as, for example, a browser program, an application program, or a part thereof. In this case, when it is determined that the mobile terminal 70 does not arrive at the store based on any one of the above-described conditions, it may be determined that the mobile terminal 70 did not arrive at the store.

When the end command is input to the mobile terminal 70, the mobile terminal 70 ends the execution of the guidance program in step S209. Next, in step S210, the mobile terminal 70 transmits, to the second management device 20, a notification indicating that the execution of the guidance program is ended, and the second management device 20 receives the notification.

Next, in step S211, the second management device 20 determines an action history of the notification user. For example, the action history is shown in the action history table 2210. The movement path is determined, for example, based on a history of the guidance status received in step S206. The movement time is, for example, a period from a time when the guidance program is transmitted, that is, a time of step S204, to a time when the execution of the guidance program is ended, that is, a time of step S209. The arrival time is, for example, the time when the execution of the guidance program is ended, and may be another time indicating that the mobile terminal 70 arrives at the store. The use store ID is a store ID of a store related to the used notification image.

Step S2 is executed as described above. After executing step S2, the advertisement system 1 analyzes an effect of an advertisement and outputs effect information in step S3. An execution timing of step S3 can be designed as appropriate. For example, step S3 may be executed only once after the end of the event. Alternatively, step S3 may be executed each time step S2 is executed during the event.

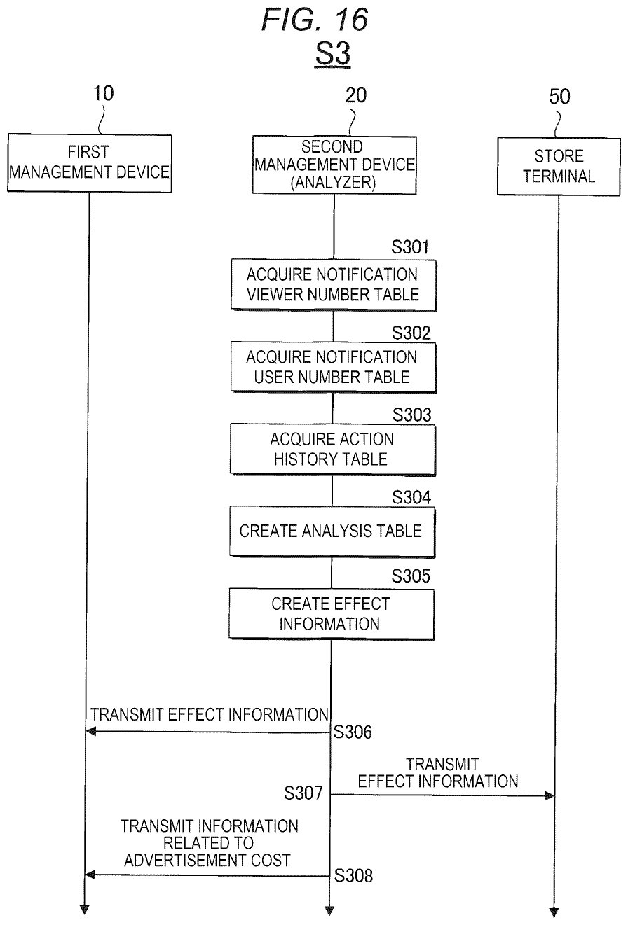

FIG. 16 shows a detailed operation example of step S3. In the operation shown in FIG. 16, processing executed by the second management device 20 is executed by, for example, the analyzer 213 in particular in the processing device 21.

In step S3, first, in step S301, the second management device 20 acquires the notification viewer number table 2207. Next, in step S302, the second management device 20 acquires the notification user number table 2209. Next, in step S303, the second management device 20 acquires the action history table 2210. The execution order of steps S301 to S303 can be freely changed.

Next, in step S304, the second management device 20 generates the analysis table 2211 based on the information acquired in steps S301 to S303. The notification viewing combination and the number of notification viewers correspond to the notification viewing combination and the number of notification viewers in the notification viewer number table 2207. The number of notification users can be obtained by searching for the notification use combination in the notification user number table 2209 based on the notification viewing combination and then acquiring the number of notification users in a corresponding row.

The second management device 20 can use an action history of the corresponding row after searching for an action history in the action history table 2210 based on a constituent ID. In particular, in the present embodiment, the movement path, the movement time, and the use store ID in the action history can be used. The action history may be narrowed down based on a store ID in addition to the constituent ID. For example, when there are a plurality of rows of action histories of the corresponding constituent ID, it is possible to extract and use one of them in which the use store ID corresponds to the notification ID. In this manner, the analysis table 2211 is generated.

Next, in step S305, the second management device 20 analyzes the effect of the advertisement based on the visit information, and then generates effect information. For example, the effect of the advertisement is analyzed based on the analysis table 2211. The effect information is, for example, information indicating an effect of an advertisement of a store to a visitor. The effect information is represented by, for example, a set of evaluation values. For example, the evaluation values are defined as follows.
Total Number of Persons; An evaluation value is represented by the total number of persons detected by the detection device 40. The total number of persons detected by the detection device 40 may be the number of persons in a time zone in which the image 31 is displayed. The total number of persons detected by the detection device 40 may be the total number including a time zone in which the image 31 is not displayed.
Attention Level of Image 31; An evaluation value is represented by the number of advertisement viewers. The evaluation value may be defined for each time zone. The time zone is, for example, a time zone defined in the notification image timetable 2206. As shown in FIG. 7, in the present embodiment, since the notification image 32 is different for each time zone, the evaluation value can be calculated for each notification image 32, that is, for each notification ID.
The Number of Viewers of Notification Image 32; An evaluation value is represented by the number of notification viewers. The evaluation value can be defined for each time zone, that is, for each notification ID.
Usage Ratio of Notification Image 32; An evaluation value is represented by a value obtained by dividing the number of notification users by the number of notification viewers. That is, the evaluation value represents a ratio of persons who have actually accessed the notification image to persons who have viewed the notification image. The evaluation value can be defined for each time zone, that is, for each notification ID.
Visit Ratio based on Notification Image 32; An evaluation value is represented by, for example, at least one of a ratio of the number of visitors to the number of advertisement viewers, a ratio of the number of visitors to the number of notification viewers, and a ratio of the number of visitors to the number of notification users. The evaluation value can be defined, for example, for each time zone, that is, for each notification ID. The evaluation value may be defined in other units.
Effect on Regional Economy; An evaluation value is represented by a value obtained by multiplying the number of visitors, that is, the number of persons who arrived at a store by an average amount of money used per consumer near the venue. The number of persons who arrived at the store is, for example, the total number of visitors for all stores. The average amount of money used per consumer near the venue may be an actual value or an estimated value. The average amount of money is separately input to the second management device 20.

Next, in step S306, the second management device 20 transmits the effect information to the first management device 10. Accordingly, the first provider can easily grasp an effect of an advertisement. The first provider is, for example, an advertisement agency. Next, in step S307, the second management device 20 transmits the effect information to the store terminal 50 of each store. Accordingly, an administrator of each store can easily grasp an effect of an advertisement. The store terminal 50 is, for example, a terminal of the first store.

An output destination of the effect information can be freely designed other than those described above. For example, the effect information may be output, that is, stored in the storage device 22 of the second management device 20. Alternatively, the effect information may be transmitted to another computer or the like. When the second management device 20 includes a display device, the effect information may be displayed on the display device. The transmission of the effect information in steps S306 and S307 may be omitted.

Next, in step S308, the second management device 20 transmits information related to an advertisement cost to the first management device 10 based on the visit information. Further, in step S308, the first management device 10 receives the information related to the advertisement cost from the second management device 20. Accordingly, the advertisement cost is charged. For example, the first provider pays the advertisement cost to the second provider. The first provider is, example, an advertisement agency. The second provider is, for example, an organizer of an event or an administrator of an outdoor advertisement.

The execution order of steps S306 to S308 can be freely changed.

A calculation method of the advertisement cost based on the visit information can be freely designed by those skilled in the art. Examples are shown below. The advertisement cost includes a usage fee of the advertisement system 1 and an advertisement posting fee. The usage fee of the advertisement system 1 is, for example, an amount determined in advance. The advertisement posting fee is an amount corrected based on a basic fee and a usage ratio of a notification image or a visit ratio based on the notification image. The advertisement posting fee may be, for example, an amount obtained by multiplying the basic fee by the usage ratio or the visit ratio. In this manner, since the advertisement posting fee varies according to a ratio of persons who actually used a store to persons who viewed an advertisement or according to a ratio of persons who are highly likely to actually use a store to persons who viewed an advertisement, the advertisement posting fee is an appropriate amount representing an actual advertisement effect. Although the usage ratio and the visit ratio are part of the effect information, since the usage ratio and the visit ratio are generated based on the visit information, it can be said that the advertisement cost is calculated based on the visit information as a whole.

The advertisement posting fee may vary according to a time during which an advertisement is displayed. For example, the image 31 can be set to have interactive contents, and an advertisement can be set to be displayed for a stay time of an advertisement viewer, that is, a time corresponding to engagement. In the advertisement set in this manner, when the interactive contents are impressive and the advertisement viewer stays for a long time, the advertisement viewer views the advertisement for a long time accordingly. In such a case, when the advertisement posting fee varies according to a time during which the advertisement is displayed, the advertisement posting fee is an appropriate amount that well represents an actual advertisement effect.

Step S3 is executed as described above, and the entire processing shown in FIG. 13 ends.

A provider that manages the first management device 10 may charge each store for an advertisement cost after step S3. Here, the first management device 10 may receive at least a part of the visit information, for example, the usage ratio of the notification image from the second management device 20. In this manner, the provider that manages the first management device 10 can charge each store for the advertisement cost according to an effect of an advertisement based on the usage ratio of the notification image or the like.

As described above, according to the advertisement system 1 in the first embodiment, since an online advertisement provider can acquire the information related to an advertisement cost from the second management device 20, an outdoor advertisement can be managed more easily. The online advertisement provider is, for example, a provider that manages the first management device 10. Therefore, a burden on the online advertisement provider when managing an outdoor advertisement is reduced.

The first embodiment described above may be modified as follows.

The display of an advertisement of a store and contents of a landing page managed by the first management device 10 may be linked. The meaning of the “landing page” can be appropriately defined by those skilled in the art. For example, when a link to a web page managed by the first management device 10 is included in a web page that is not managed by the first management device 10, the web page that is a link destination is the landing page. The landing page is, for example, a landing page of an online advertisement. The definition of the landing page is not limited thereto.

A specific example of linking with the landing page will be described below. In relation to step S103, the second management device 20 may transmit, to the first management device 10, information indicating a time when an advertisement of a store is displayed in a public place. Hereinafter, a time when an advertisement of a store is displayed in a public place may be referred to as an “advertisement display time”. The first management device 10 may acquire information indicating the advertisement display time by receiving the information from the second management device 20. This is achieved, for example, by transmitting and receiving the notification image timetable 2206 prior to step S103 or in parallel with step S103.

The first management device 10 manages a landing page including a web page related to an online advertisement of the first management device 10. The first management device 10 displays an advertisement of a store on the landing page of the online advertisement of the first management device 10 during a period corresponding to the advertisement display time. Hereinafter, the period corresponding to the advertisement display time may be referred to as a “first period”. The first period may match, for example, a time zone in which a notification image of the store is displayed. One or both of a start time and an end time of the first period may be different from those in the time zone in which the notification image of the store is displayed.

In this manner, since the display of the advertisement of the store by the display device 30 and the display of the advertisement of the store on the landing page can be linked, an effect of the advertisement is enhanced. In a period other than the first period, the advertisement of the store may not be displayed on the landing page of the online advertisement of the first management device 10.

Alternatively, the first management device 10 may change a display mode of the advertisement of the store displayed on the landing page of the online advertisement between the first period and a period other than the first period. For example, the advertisement of the store is displayed on the landing page of the online advertisement regardless of a time zone. Here, in the first period, the advertisement of the store is displayed in a more conspicuous mode than in the other periods. Examples of the more conspicuous mode include a larger size, a larger character, and display at a position close to the head of the page. The position close to the head is, for example, the vicinity of the top.

In the first embodiment, an advertisement to be displayed may be determined according to a positional relationship between a public place and a store. That is, an advertisement of which store is to be displayed may be determined according to a positional relationship between a public place and the store. For example, the store information 2203 may store information indicating positions of a plurality of stores. Then, the second management device 20 may select a store whose advertisement is to be displayed from a plurality of stores based on a position of a public place and a position of each of the plurality of stores. In particular, a store closer to the public place may be preferentially selected. For example, a result of the selection is stored in the notification image timetable 2206. In this manner, since an advertisement and a notification image of a closer store are preferentially displayed, it is possible to increase a possibility that a notification user actually visits the store.

Such a configuration is more suitable when there are a plurality of public places for displaying an advertisement. In particular, in each public place, since an advertisement of a store close to the public place is preferentially displayed, the advertisement is optimized according to a place.

The visit information may include information other than those described in the first embodiment. For example, the visit information may include all pieces of the information shown in FIGS. 5 to 12.

A part of the visit information, for example, the movement path is acquired based on position information of the mobile terminal 70 carried by a visitor in the first embodiment. Alternatively, the movement path may be acquired based on other kinds of information in addition to or instead of the position information.

For example, a digital coupon may be issued in a public place in association with the display of an advertisement of a store. In this case, the visit information may be acquired based on a use history of the digital coupon in the store. More specifically, the notification image represents a digital coupon. When the digital coupon is presented and used in the store, the second management device 20 determines that a visitor arrives at the store. Here, the store terminal 50 may include a reading device for reading the digital coupon. When the reading device reads the digital coupon, it may be determined that the digital coupon is used in the store.

Alternatively, for example, a coupon printed on a print medium may be used. For example, a coupon printed on a print medium may be issued in a public place in association with display of an advertisement of a store. In this case, the visit information may be acquired based on information indicating that a reading device of the store reads the coupon. Here, the store terminal 50 may function as a reading device for reading a printed coupon.

Alternatively, the store terminal 50 may include a reading device for reading the printed coupon. Alternatively, for example, the visit information may be acquired based on electronic data indicating a questionnaire result in a store. For example, the visitor may input an answer to a questionnaire presented in the store via the mobile terminal 70. The mobile terminal 70 transmits a questionnaire result including the answer to the second management device 20. The second management device 20 receives the questionnaire result.

To summarize the above, the visit information may be acquired based on any one of
position information of the mobile terminal t 70 carried by a visitor,
a use history in the first store of a digital coupon issued in the public place in association with the display of an advertisement of the first store,
information indicating that a reading device of the first store reads a coupon printed on a print medium, which is issued in a public place in association with the display of an advertisement of the first store, and
electronic data indicating a questionnaire result in the first store. In this manner, the visit information can be flexibly acquired by various methods according to a system configuration.

The advertisement system 1 may dynamically generate or change the image 31. For example, the second management device 20 may dynamically generate an image based on the visit information. Alternatively, the second management device 20 may generate an image based on action information indicating an action of the advertisement viewer 60 who has viewed an advertisement of a store. Then, the second management device 20 may transmit the generated image to the display device 30. The display device 30 may receive the generated image and display the image in a public place instead of the image 31, in addition to the image 31, or in a superimposed manner on the image 31. The generated image may be an image in which an advertisement or a part thereof is changed. The generated image may be a representation image that is not an advertisement or an image obtained by changing a part of the representation image. The generated image may be a background image or an image obtained by changing a part of the background image.

Alternatively, the second management device 20 may generate an instruction to change the image 31 based on at least one of the visit information and the action information. The second management device 20 may transmit the generated instruction to the display device 30. The display device 30 may generate a new image by changing the image 31 according to the instruction. The display device 30 may display the generated image. Here, “creation of a new image” includes replacing a part or all of an image displayed so far with another existing image, superimposing another image on the image displayed so far, and the like.

Further, the display device 30 may dynamically generate an image without depending on the second management device 20. For example, the detection device 40 may transmit action information indicating an action of the advertisement viewer 60 to the display device 30. The display device 30 may generate an image based on the action information.

In any one case, it can be said that the display device 30 displays an image generated based on at least one of the visit information and the action information.

When an image is generated based on the visit information, for example, an advertisement that was valid in the past may be reused. As a specific example, when there are a plurality of types of advertisements for a store and an advertisement viewer who has viewed any one of the advertisements actually visits the store, a new image can be generated by directly reusing the advertisement or by changing a part of the advertisement. In this manner, since an advertisement that was actually effective is preferentially used, the entire advertisement effect is enhanced.

As another specific example, when a specific constituent type, for example, a family group that has viewed an advertisement of a store actually visits a store, an image targeting on the constituent type, for example, the family may be generated. As a specific example, an image in which a message such as “recommended to family” is additionally displayed may be generated. In this manner, since it is possible to appeal to a target with a higher effect, the effect of an advertisement is enhanced.

Specific examples of the action information include, but are not limited to, a change in a position of a viewer, a movement of the body of a viewer, a reaction of a viewer to a dynamically displayed number, stepping by a viewer, and the like. When an image generated based on such action information is displayed, the image can be made interactive, so that the degree of attention of a viewer to a change in the image increases, and an effect of an advertisement is enhanced.

Each store is charged for an advertisement cost by a provider that manages the first management device 10 in the first embodiment. The advertisement system 1 is not involved in such a charge. As a modification, an advertisement system may charge each store for an advertisement cost. In particular, when the first provider is about to receive payment of the advertisement cost from each store, the second provider may collect the advertisement cost from each store. The first provider is, for example, an advertisement agency. The second provider is, for example, an organizer of an event or an administrator of an outdoor advertisement. This modification will be described below.

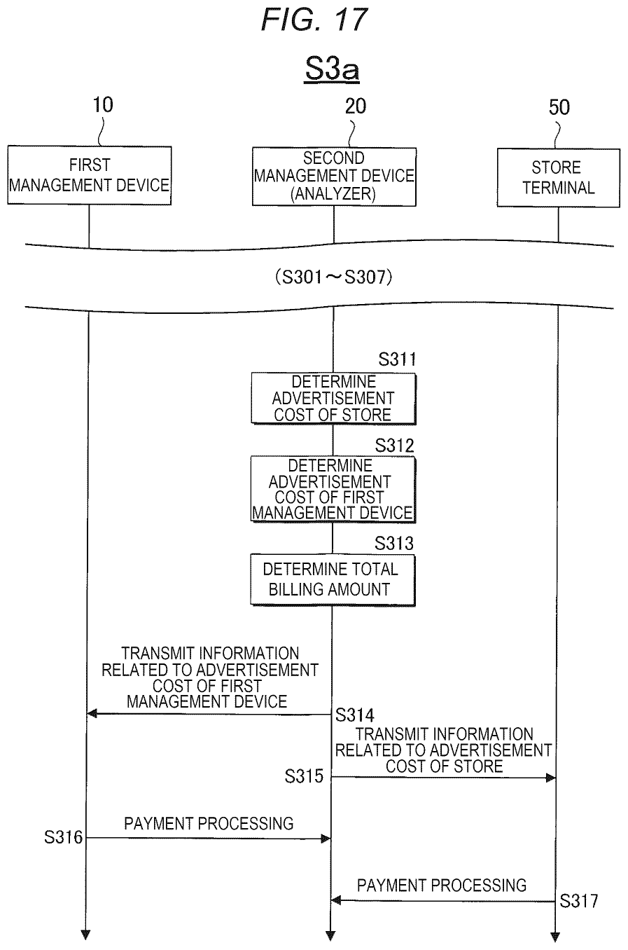

FIG. 17 shows a part of a detailed operation of step S3a which is a step corresponding to step S3 in the present modification. Contents of step S3a are obtained by replacing step S308, that is, the transmission and reception processing of the information related to the advertisement cost in step S3 shown in FIG. 16 with steps S311 to S316 in FIG. 17. For convenience of description, steps S301 to S307 are omitted, and steps S301 to S307 may be the same as those in FIG. 16.

After step S307, in step S311, the second management device 20 determines an advertisement cost of a store. The advertisement cost of a store is an advertisement cost that each store should pay to either the first provider or the second provider. The advertisement cost may be hereinafter referred to as a “store cost”. The store cost is, for example, a first store cost. The store cost is determined based on, for example, a basic fee and the visit information. More specifically, the store cost is determined based on, for example, at least one of a usage ratio of notification information and a visit ratio.

Next, in step S312, the second management device 20 determines the advertisement cost of the first management device 10. The advertisement cost of the first management device 10 is a cost that the first provider should pay to the second provider. The advertisement cost of the first management device 10 is, for example, a usage fee of an advertisement system. Next, in step S313, the second management device 20 sums the advertisement cost of each store and the advertisement cost of the first management device 10 to determine a total billing amount. The sum may be a simple addition. The sum may be a calculation result including another correction calculation. The correction calculation may include a discount calculation or the like defined in advance. The sum may be determined based on the visit information. The sum may be determined based on, for example, at least one of the usage ratio of the notification information and the visit ratio. In this manner, the second management device 20 determines the total billing amount based on the visit information.

Next, in step S314, the second management device 20 transmits information related to the advertisement cost of the first management device 10 to the first management device 10. In step S314, the first management device 10 receives the information. In step S314, information related to the advertisement cost of each store may be further transmitted and received. Next, in step S315, the second management device 20 transmits information related to the advertisement cost of each store to each store terminal 50. In step S315, each store terminal 50 receives the information. As described above, based on the visit information, the second management device 20 transmits, to the store terminal 50, information related to the store cost to be paid by the store that manages the store terminal 50. The store cost to be paid by the store is, for example, the first store cost to be paid by the first store.

Next, in step S316, the second management device 20 receives payment processing of the advertisement cost of the first management device 10 from the first management device 10 or the first provider. Similarly, in step S317, the second management device 20 receives payment processing of the advertisement cost of a store from each store terminal 50 or from each store. The payment processing can be executed via, for example, a known settlement system. The second management device 20 may determine that the payment processing is received in response to receiving a notification indicating that the settlement of the payment processing is completed from a settlement system.

Here, as described above, in step S313, since the total billing amount is calculated as the sum of the advertisement cost of each store and the advertisement cost of the first management device 10, it can be said that information related to the advertisement cost of the first management device 10 is information indicating a result of subtracting the advertisement cost of each store from the total billing amount. Here, the reduction is not limited to simple subtraction, and for example, a correction calculation or the like may be performed on the reduction.

According to the modification related to step S3a described above, the second provider can take over money collection processing from each store, which should be originally performed by the first provider, and a burden on the first provider is reduced.

In FIG. 17, the execution order of the steps can be appropriately changed. For example, step S315 can be executed at any timing after step S311 and before step S317 regardless of an execution status of other steps.

In the first embodiment, the constituent ID is used in the analysis table 2211 or the like. That is, for the notification information, a person who uses the notification information is specified from viewers. As a modification, the constituent ID may not be used. That is, the visit information can be generated in a state where a relationship between a viewer and a person who actually uses the notification information cannot be specifically obtained.

In such a case, in particular, a usage ratio of the notification image may be represented by a value obtained by dividing the number of times the notification information is used by the number of times the notification information is displayed. That is, an evaluation value indicates how efficiently a displayed notification image is accessed. The evaluation value can be defined for each time zone, that is, for each notification ID.

Those skilled in the art can freely add, change, or delete components in the first embodiment and the modifications. For example, the second management device 20 can be implemented by a plurality of computers connected via a communication network. In this case, each of the advertisement processor 211, the guidance unit 212, and the analyzer 213 may be implemented by a single computer. Alternatively, any one or all of the advertisement processor 211, the guidance unit 212, and the analyzer 213 may be implemented by a plurality of computers.

The order of the steps described in FIGS. 13 to 17 including a case described in the first embodiment can be appropriately changed.

### APPENDICES

The present disclosure will be summarized below as appendices.

### Appendix 1

An advertisement method including: acquiring, by a second management device, first advertisement information indicating an advertisement of a first store from a first management device that manages advertisement information of a plurality of actual stores including the first store; acquiring, by a display device, the first advertisement information from the second management device; displaying, by the display device, the advertisement of the first store in a public place in a size viewable by multiple persons based on the first advertisement information; acquiring, by the second management device, visit information on a visitor to the first store; and transmitting, by the second management device, information related to an advertisement cost to the first management device based on the visit information, in which the visitor is a person who visits the first store based on the advertisement of the first store displayed in the public place.

According to the advertisement method of Appendix 1, since a provider that manages the f first management device can acquire the information related to the advertisement cost from the second management device, an outdoor advertisement can be managed more easily.

### Appendix 2

The advertisement method according to Appendix 1, further including: generating, by the second management device, effect information indicating an effect of the advertisement of the first store for the visitor based on the visit information; and transmitting, by the second management device, the effect information to a terminal of the first store.

According to the advertisement method of Appendix 2, an administrator of each store can easily grasp the effect of the advertisement.

### Appendix 3

The advertisement method according to Appendix 1 or 2, further including: generating, by the second management device, effect information indicating an effect of the advertisement of the first store for the visitor based on the visit information; and transmitting, by the second management device, the effect information to the first management device.

According to the advertisement method of Appendix 3, a provider that manages the first management device can easily grasp the effect of the advertisement.

### Appendix 4

The advertisement method according to any one of Appendices 1 to 3, further including: acquiring, by the second management device, action information indicating an action of an advertisement viewer who viewed the advertisement of the first store based on a detection result of a sensor in the public place; and displaying, by the display device, an image generated based on at least one of the visit information and the action information.

According to the advertisement method of Appendix 4, the effect of the advertisement is enhanced.

### Appendix 5

The advertisement method according to any one of Appendices 1 to 4, further including: determining, by the second management device, a total billing amount based on the visit information; transmitting, by the second management device, information related to a first store cost to be paid by the first store to a terminal of the first store, based on the visit information; and receiving, by the second management device, payment processing of the first store cost from the first store via a settlement system, in which the information related to the advertisement cost is information indicating a result of subtracting the first store cost from the total billing amount.

According to the advertisement method of Appendix 5, a second provider can take over money collection processing from each store, which should be originally performed by the first provider, and a burden on the first provider is reduced.

### Appendix 6

The advertisement method according to any one of Appendices 1 to 5, further including: transmitting, by the second management device, information indicating a time when the advertisement of the first store is displayed to the first management device.

According to the advertisement method of Appendix 6, the display of the advertisement of the first store by the display device and the display of the advertisement of the first store on a landing page of an online advertisement by the first management device can be linked, and the effect of the advertisement is enhanced.

### Appendix 7

The advertisement method according to any one of Appendices 1 to 6, further including: selecting, by the second management device, the first store from the plurality of stores based on a position of the public place and a position of each of the plurality of stores.

According to the advertisement method of Appendix 7, an advertisement and a notification image of a closer store are preferentially displayed, and a notification user is more likely to actually visit the store.

### Appendix 8

The advertisement method according to any one of Appendices 1 to 7, in which the visit information is acquired based on any one of position information of a mobile terminal carried by the visitor, a use history in the first store of a digital coupon issued in the public place in association with display of the advertisement of the first store, information indicating that a reading device of the first store reads a coupon printed on a print medium, which is issued in the public place in association with the display of the advertisement of the first store, and electronic data indicating a questionnaire result in the first store.

According to the advertisement method of Appendix 8, visit information can be flexibly acquired by various methods according to a system configuration.

### Appendix 9

The advertisement method according to any one of Appendices 1 to 8, further including: displaying, by the display device, information indicating a first URL in association with the advertisement of the first store; transmitting, by the second management device, guidance information for guiding the visitor to the first store in response to access from the mobile terminal to the first URL; and acquiring, by the second management device, the visit information based on information indicating a position of the mobile terminal after the guidance information is transmitted.

According to the advertisement method of Appendix 9, a subsequent action of the advertisement viewer who is interested in the advertisement can be tracked with high accuracy.

### Appendix 10

An advertisement system including: a second management device; and a display device, in which the second management device acquires first advertisement information indicating an advertisement of a first store from a first management device that manages advertisement information of a plurality of actual stores including the first store, the display device acquires the first advertisement information from the second management device, the display device displays the advertisement of the first store in a size viewable by multiple persons in a public place based on the first advertisement information, the second management device acquires visit information on a visitor to the first store, the second management device transmits information related to an advertisement cost to the first management device based on the visit information, and the visitor is a person who visits the first store based on the advertisement of the first store displayed in the public place.

According to the advertisement system of Appendix 10, since a provider that manages the first management device can acquire the information related to the advertisement cost from the second management device, an outdoor advertisement can be managed more easily.

### Appendix 11

An advertisement management method including: managing advertisement information of a plurality of actual stores including a first store; transmitting first advertisement information indicating an advertisement of the first store to a second management device; and receiving information related to an advertisement cost from the second management device, in which the information related to the advertisement cost is information based on information related to a visitor who visits the first store based on the advertisement of the first store displayed in a public place.

According to the advertisement management method of Appendix 11, since a provider that manages the first management device can acquire the information related to the advertisement cost from the second management device, an outdoor advertisement can be managed more easily.

### Appendix 12

The advertisement management method according to Appendix 11, further including: acquiring, from the second management device, information indicating an advertisement display time when the advertisement of the first store is displayed in the public place; and executing at least one of displaying the advertisement of the first store on a landing page of an online advertisement in a first period corresponding to the advertisement display time, and making a display mode of the advertisement of the first store displayed on the landing page different between the first period and a period other than the first period.

According to the advertisement management method of Appendix 12, the display of the advertisement of the first store by the display device and the display of the advertisement of the first store on the landing page of the online advertisement by the first management device can be linked, and the effect of the advertisement is enhanced.

What is claimed is:

1. An advertisement method comprising:
acquiring, by a second management device, first advertisement information indicating an advertisement of a first store from a first management device that manages advertisement information of a plurality of actual stores including the first store;
acquiring, by a display device, the first advertisement information from the second management device;
displaying, by the display device, the advertisement of the first store in a public place in a size viewable by multiple persons based on the first advertisement information;
acquiring, by the second management device, visit information on a visitor to the first store; and
transmitting, by the second management device, information related to an advertisement cost to the first management device based on the visit information, wherein
the visitor is a person who visits the first store based on the advertisement of the first store displayed in the public place.

2. The advertisement method according to claim 1, further comprising:
generating, by the second management device, effect information indicating an effect of the advertisement of the first store for the visitor based on the visit information; and
transmitting, by the second management device, the effect information to a terminal of the first store.

3. The advertisement method according to claim 1, further comprising:
generating, by the second management device, effect information indicating an effect of the advertisement of the first store for the visitor based on the visit information; and
transmitting, by the second management device, the effect information to the first management device.

4. The advertisement method according to claim 1, further comprising:
acquiring, by the second management device, action information indicating an action of an advertisement viewer who viewed the advertisement of the first store based on a detection result of a sensor in the public place; and
displaying, by the display device, an image generated based on at least one of the visit information and the action information.

5. The advertisement method according to claim 1, further comprising:
determining, by the second management device, a total billing amount based on the visit information;
transmitting, by the second management device, information related to a first store cost to be paid by the first store to a terminal of the first store, based on the visit information; and
receiving, by the second management device, payment processing of the first store cost from the first store via a settlement system, wherein
the information related to the advertisement cost is information indicating a result of subtracting the first store cost from the total billing amount.

6. The advertisement method according to claim 1, further comprising:
transmitting, by the second management device, information indicating a time when the advertisement of the first store is displayed to the first management device.

7. The advertisement method according to claim 1, further comprising:
selecting, by the second management device, the first store from the plurality of stores based on a position of the public place and a position of each of the plurality of stores.

8. The advertisement method according to claim 1, wherein
the visit information is acquired based on any one of
position information of a mobile terminal carried by the visitor,
a use history in the first store of a digital coupon issued in the public place in association with display of the advertisement of the first store,
information indicating that a reading device of the first store reads a coupon printed on a print medium, which is issued in the public place in association with the display of the advertisement of the first store, and
electronic data indicating a questionnaire result in the first store.

9. The advertisement method according to claim 1, further comprising:
displaying, by the display device, information indicating a first URL in association with the advertisement of the first store;
transmitting, by the second management device, guidance information for guiding the visitor to the first store in response to access from a mobile terminal to the first URL; and
acquiring, by the second management device, the visit information based on information indicating a position of the mobile terminal after the guidance information is transmitted.

10. An advertisement system comprising:
a second management device; and
a display device, wherein
the second management device acquires first advertisement information indicating an advertisement of a first store from a first management device that manages advertisement information of a plurality of actual stores including the first store,
the display device acquires the first advertisement information from the second management device,
the display device displays the advertisement of the first store in a size viewable by multiple persons in a public place based on the first advertisement information,
the second management device acquires visit information on a visitor to the first store,
the second management device transmits information related to an advertisement cost to the first management device based on the visit information, and
the visitor is a person who visits the first store based on the advertisement of the first store displayed in the public place.

11. An advertisement management method comprising:
managing advertisement information of a plurality of actual stores including a first store;
transmitting first advertisement information indicating an advertisement of the first store to a second management device; and
receiving information related to an advertisement cost from the second management device, wherein
the information related to the advertisement cost is information based on information related to a visitor who visits the first store based on the advertisement of the first store displayed in a public place.

12. The advertisement management method according to claim 11, further comprising:
acquiring, from the second management device, information indicating an advertisement display time when the advertisement of the first store is displayed in the public place; and
executing at least one of
displaying the advertisement of the first store on a landing page of an online advertisement in a first period corresponding to the advertisement display time, and
making a display mode of the advertisement of the first store displayed on the landing page different between the first period and a period other than the first period.
